(19) United States
(12) Patent Application Publication
(10) Pub. No.: US 2026/0056564 A1
(43) Pub. Date: Feb. 26, 2026

(54) IOT-BASED AUTOMATED VOLTAGE CONTROLLER SYSTEM FOR MOTOR OPERATED THREE-PHASE AUTOTRANSFORMER

(71) Applicants: Ramesh Kumar, Rajasthan (IN); Mohammad Aljaidi, Zarqa (JO); Pawan Kumar Pandey, Uttar Pradesh (IN); Muteb Eid Alshammari, Rafha (SA); Manish Kumar Singla, Punjab (IN); Amjad Alasmar Alsuwaylimi, Arar (SA); Kaznah Magbel Alshammari, Rafha (SA); Samar Hussni Anbarkhan, Rafha (SA); Ahmad Abdullah Alshammari, Rafha (SA); Nasser Albalawi, Rafha (SA)

(72) Inventors: Ramesh Kumar, Rajasthan (IN); Mohammad Aljaidi, Zarqa (JO); Pawan Kumar Pandey, Uttar Pradesh (IN); Muteb Eid Alshammari, Rafha (SA); Manish Kumar Singla, Punjab (IN); Amjad Alasmar Alsuwaylimi, Arar (SA); Kaznah Magbel Alshammari, Rafha (SA); Samar Hussni Anbarkhan, Rafha (SA); Ahmad Abdullah Alshammari, Rafha (SA); Nasser Albalawi, Rafha (SA)

(21) Appl. No.: 18/887,649

(22) Filed: Sep. 17, 2024

(30) Foreign Application Priority Data
Aug. 22, 2024 (IN) 202411063420

(51) Int. Cl. G05F 1/20; H01F 30/02; H02P 13/06

(52) U.S. Cl. CPC G05F 1/20; H01F 30/02; H02P 13/06

(57) ABSTRACT

In an aspect of the present disclosure, an IoT-based automated voltage controller system for motor-operated three-phase autotransformer is disclosed and a method thereof. The controller system includes a single-phase bidirectional synchronous motor mechanically connected with a shaft of the autotransformer. The motor changes tapping of windings of the autotransformer through dials. A switch mode power supply (SMPS) circuit is configured to supply power to the voltage controller unit, which primarily steps down the voltage to 5V and rectify thereto into DC voltage. An Arduino-nano microcontroller associated with a plurality of modules. The modules are configured such that the output voltage of the motor-operated three-phase autotransformer remains either constant or varies at +4V irrespective of nature of power supply automatically during full load conditions, thereby compensating supply voltage fluctuations.

### CROSS-REFERENCE TO PRIOR APPLICATIONS

This application claims the benefit of conventional India patent application No. 202411063420 filed on Aug. 22, 2024, the contents of which are incorporated by reference.

### TECHNICAL FIELD

The present disclosure generally relates to Electrical systems. More specifically, the present disclosure relates to an IoT-based automated voltage control system for motor-operated three-phase Autotransformer and a method thereof.

### BACKGROUND

Autotransformer plays a vital role in electrical system. The Autotransformer is an ideal for voltage adjustment for commercial and industrial machines as it provides an efficient, low-cost way of serving the proper voltage to motors and compressors, lathes, CNC machines, and other industrial equipment requiring a step up or down from a building's service voltage. The Autotransformer is a single-winding transformer that works on the principle of Faraday's Law of electromagnetic induction, where the electrical power is transferred by induction and conduction, and by projecting taps at different levels on the secondary side, a wide range of voltage can be obtained. It is also known as variac, dimmer stat, etc. A three-phase Autotransformer uses three windings connected in star configuration for operation under a three-phase balanced supply also provided with a neutral point.

Tapping of an autotransformer refers to changing the transformer's effective turns ratio by connecting the load at different points along the winding. Initially, the autotransformer's dial is set to a starting position, which typically corresponds to tapping at the primary winding's full turns. To step up the voltage using an autotransformer, the primary winding is connected to the input voltage source, and the load is connected to the secondary winding. The load is connected across a portion of the winding with more turns than the portion connected to the input voltage source. The voltage across the load (secondary voltage) will be higher than the voltage applied to the primary winding (input voltage) due to the turn ratio of the autotransformer. To step down the voltage using an autotransformer, the primary winding is connected to the load, and the input voltage source is connected to the secondary winding. The input voltage is applied across a portion of the winding with more turns than the portion connected to the load. The voltage across the load (connected to the secondary winding) will be lower than the voltage applied to the primary winding (input voltage) due to the turn ratio of the autotransformer.

The conventional three-phase autotransformers have certain limitations associated therewith. At “no load” and “full load” terminals, voltage levels vary. For Instance, at “full load”, supply voltage decreases. Thus, there should be voltage stability at load terminals employing continuous adjustment of the tapping. The conventional prior arts involve manual effort of rotating the dial of the three-phase autotransformer, leading to human errors in voltage readings. In a nutshell, when there is voltage sag, voltage swell or voltage fluctuations in the supply voltage, output voltage is not constant.

Furthermore, the conventional arts are reliant on manual operation. The previous system, requiring a hand-operated switch (LW) to regulate voltage, which can be less precise and time-consuming, especially in dynamic load conditions.

Therefore, there is a need for developing alternatives to get rid of aforementioned prior arts.

### SUMMARY

In an embodiment, the present disclosure discloses an IoT-based automated voltage controller system (100) for motor-operated three-phase autotransformer (150). The controller system (100) includes a single-phase bidirectional synchronous motor (102) mechanically connected with a shaft of the autotransformer (150). The motor (102) includes a series combination of a wire-wound resistor and a capacitor connected in parallel to the windings thereof that change tapping of windings of the autotransformer (150) through dials. Two voltage sensors (V1, V2) are connected to output of the autotransformer (150). A switch mode power supply (SMPS) circuit (104) is configured to supply power to the voltage controller unit, which primarily steps down the voltage to 5V and rectify thereto into DC voltage. A LCD display (106) is configured for displaying live data such that the current through the autotransformer is not beyond the specified rating. An alpha-numeric keypad (108) to input target output voltage. An Arduino-nano microcontroller (110) associated with a plurality of modules. The modules are configured such that the output voltage of the motor-operated three-phase autotransformer (150) remains either constant or varies at +4V irrespective of nature of power supply automatically during full load conditions, thereby compensating supply voltage fluctuations.

In another aspect of the present disclosure, an automated method (200) for maintaining output voltage of a motor-operated three-phase autotransformer (150) constant during full load conditions is disclosed. The method (200) involves providing initial voltage input to the autotransformer (150) to activate thereto, followed by providing no output voltage initially. The method (200) further involves establishing a feedback loop through a voltage sensor (V1 or V2) for continuously monitoring an actual output voltage, followed by providing a desired reference voltage by an operator and comparing the reference voltage to the feedback voltage by an Arduino nano microcontroller (110). The microcontroller (110) activates either a forward or backward relay to adjust rotation of the autotransformer (150), thereby increasing or decreasing the output voltage as needed and continuously monitors and adjusts the autotransformer (150) to minimize differences between the reference and feedback voltages. The method (200) further involves displaying the achieved final output voltage is achieved on a LCD display (106).

### BRIEF DESCRIPTION OF DRAWINGS

Other objects, features, and advantages of the embodiment will be apparent from the following description when read with reference to the accompanying drawings. In the drawings, reference numerals denote corresponding parts throughout the several views:

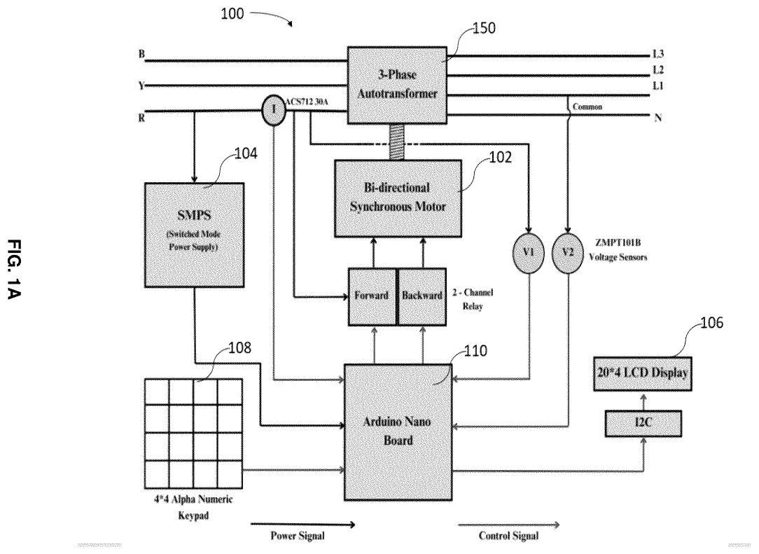

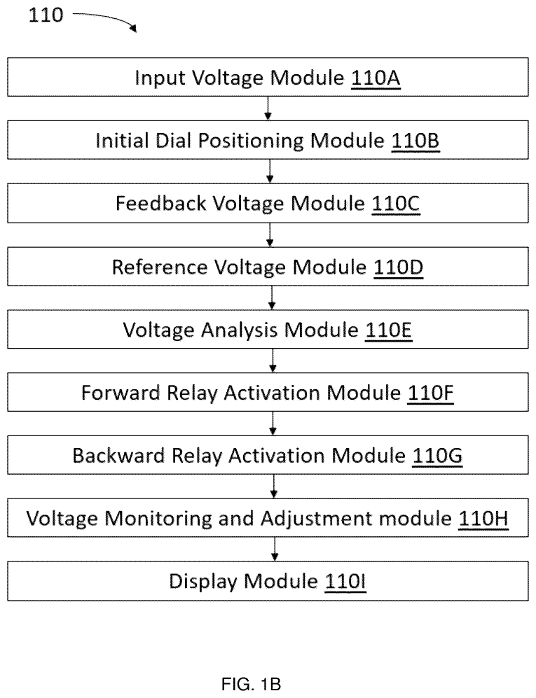

Referring to FIG. 1A, shows a schematic block representation of various components of an IoT-based automated voltage controller system (100) for motor-operated three-phase autotransformer (150), in accordance with an illustrative embodiment of a present disclosure;

Referring to FIG. 1B, shows a schematic block representation of working of the IoT-based automated voltage controller system (100) for motor-operated three-phase autotransformer (150), in accordance with the illustrative embodiment of the present disclosure;

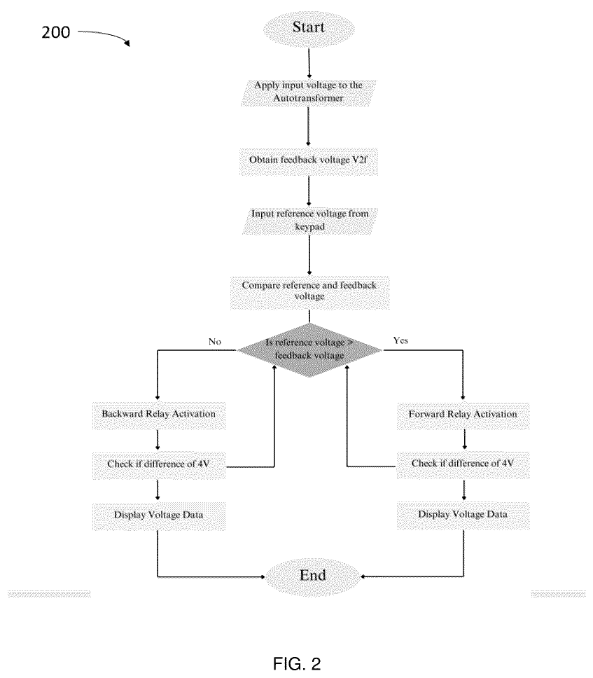

Referring to FIG. 2, shows a flowchart depicting steps of a method (200) for automated voltage control of the motor-operated three-phase autotransformer (150), in accordance with another illustrative embodiment of the present disclosure;

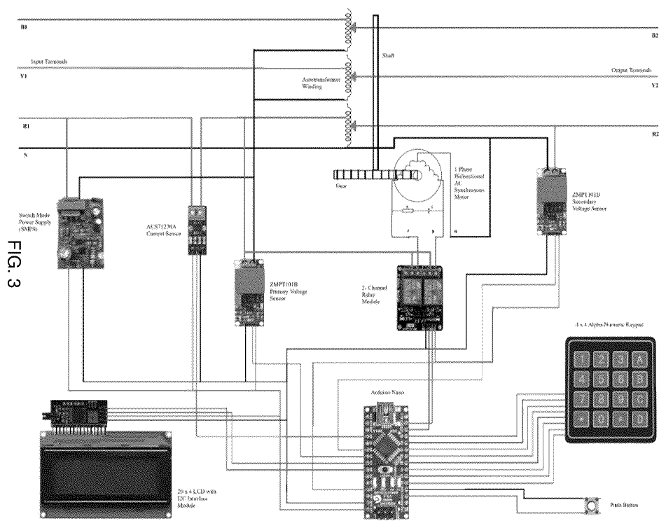

Referring to FIG. 3, shows a circuit view of the IoT-based automated voltage control of the motor-operated three-phase autotransformer (150), in accordance with another illustrative embodiment of the present disclosure; and

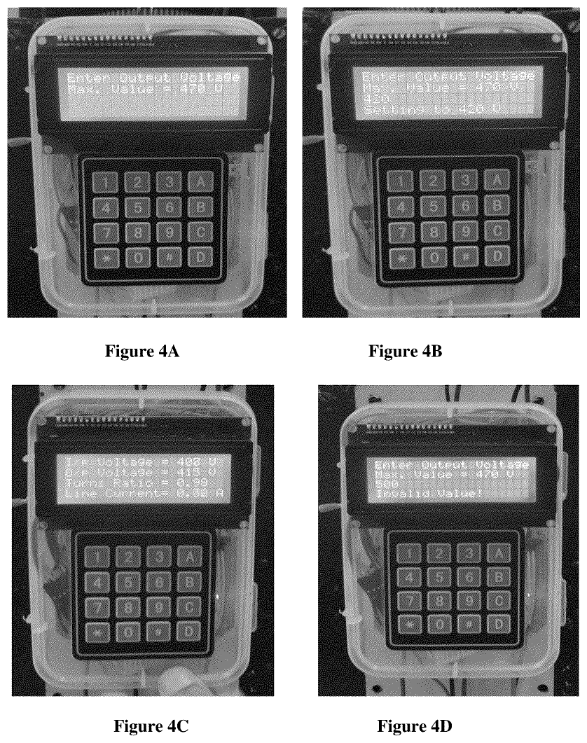

Referring to FIGS. 4A-4D, show different steps: FIG. 4A shows the Controller system (100) asking for a value, FIG. 4B shows a dial moving to set voltage, FIG. 4C shows display of live data, FIG. 4D shows display of error message, in accordance with the illustrative embodiment of the present disclosure.

### DETAILED DESCRIPTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Various terms as used herein are shown below. To the extent a term used in a claim is not defined below, it should be given the broadest definition persons in the pertinent art have given that term as reflected in printed publications and issued patents at the time of filing.

Where a definition or use of a term in an incorporated reference is inconsistent or contrary to the definition of that term provided herein, the definition of that term provided herein applies and the definition of that term in the reference does not apply.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

As used herein, the singular forms “a”, “an”, and “the” include plural referents unless the context clearly dictates otherwise. Further, the terms “like”, “as such”, “for example”, and “including” are meant to introduce examples that further clarify the more general subject matter, and should be contemplated for the persons skilled in the art to understand the subject matter.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

The present disclosure generally relates to an IoT-based automated voltage controller system (100) for motor-operated three-phase autotransformer (150) as shown in FIG. 1A. The controller system (100) includes a single-phase bidirectional synchronous motor (102) mechanically connected with a shaft of the autotransformer (150) which changes the tapping of the windings through dials. The mechanical linking is done through a gear arrangement of gears with a teeth count of 96:48:16. On combining, give the final reduction ratio of 6:1. Such a gear reduction is necessary for the arrangement for increasing the torque required to turn the tapping shaft of the autotransformer through a gear arrangement of gears with a gear reduction ratio of 6:1. The gear reduction increases torque required to turn the tapping shaft of the autotransformer (150). The motor (102) turns in forward and backward directions and is configured for rotation of tapping dials of the autotransformer (150). Such an arrangement also includes three limiting switches of which any two switches are used for limiting the further rotation of the tapping on either side of the windings i.e. Initial point (0V) and Final point (470V).

The motor includes a series combination of a wire-wound resistor and a capacitor connected in parallel to the windings thereof that change tapping of windings of the autotransformer (150) through dials. The single-phase bidirectional synchronous motor (102) includes such as but not limited to a permanent magnet synchronous motor, a switched reluctance motor.

There are two voltage sensors (V1, V2) connected to output of the autotransformer (150). A hall effect current sensor is connected to sense current flow through the autotransformer (150). A switch mode power supply (SMPS) circuit (104) is configured to supply power to an Arduino-nano microcontroller (110).

A LCD display (106) is connected to the Arduino-nano microcontroller (110). The display (106) is configured for displaying live data such that the current through the autotransformer is not beyond the specified rating. An alpha-numeric keypad (108) to input desired output voltage as fed by an operator. Such a keypad (108) is connected to the Arduino-nano microcontroller (110).

The Arduino-nano microcontroller (110) is associated with a plurality of modules as shown in FIG. 1B. The modules include such as but not limited to an input voltage module (110A), an initial dial positioning module (110B), a feedback voltage module (110C), a reference voltage module (110D), a voltage analysis module (110E), a forward relay activation module (110F), a backward relay activation module (110G), a voltage monitoring and adjustment module (110H), and a display module (1101).

The input voltage module (110A) is configured to receive initial voltage supplied to the autotransformer (150) to activate thereto to be operational. The initial voltage (V1) is the primary input to the autotransformer (150).

The initial dial positioning module (110B) is configured to set the dial of the autotransformer (150) at zero output voltage, corresponding to tapping at a primary winding's full turns. The autotransformer's dial is set to the starting position, which corresponds to an output voltage of 0. This means that initially, the autotransformer is not providing any voltage to the load connected to its secondary side.

The feedback voltage module (110C) receives voltage from one of the two voltage sensors to provide feedback to the microcontroller (110) about the actual output voltage generated by the autotransformer (150). This voltage is obtained from one of the two voltage sensors (V1, V2) which are connected to the output of the autotransformer (150). It provides feedback to the microcontroller (110) about the actual output voltage being generated by the autotransformer (150).

The reference voltage module (110D) receives a reference voltage as input by an operator using the alpha-numeric keypad (108) connected to the microcontroller (110). The reference voltage is the desired output voltage of the autotransformer (150).

The voltage analysis module (110E) compares the reference voltage with the feedback voltage obtained from the voltage sensor immediately as the reference voltage is received.

The forward relay activation module (110F) activates the forward relay if the reference voltage is greater than the feedback voltage. If the reference voltage is greater than the feedback voltage, indicating that the output voltage needs to be increased, the microcontroller (110) activates the forward relay. The forward relay then energizes the motor (102), causing the shaft of the autotransformer (150) to rotate clockwise. Such a rotation continues until the feedback voltage becomes equal to the reference value of the voltage.

The backward relay activation module (110G) activates the backward relay if the reference voltage is lesser than the feedback voltage. Conversely, if the reference voltage is lesser than the feedback voltage, indicating that the output voltage needs to be decreased, the microcontroller (110) activates the backward relay. Such a relay also energizes the motor (102) but rotates the shaft of the autotransformer anticlockwise until the feedback voltage and the reference voltage become equal.

The voltage monitoring and adjustment module (110H) continuously monitors the feedback voltage and adjusts operation of the autotransformer to maintain a minimum difference of 4 Volts between the reference and feedback voltages during operation, thereby ensuring efficient regulation and minimizes errors in the output voltage.

The display module (1101) displays the desired output voltage as on the LCD display (106). The displayed information typically includes the input voltage, output voltage, turns ratio (V1/V2), and line current (if any load is connected).

The output voltage of the motor-operated three-phase autotransformer (150) remains either constant or varies at +4V irrespective of nature of power supply automatically during full load conditions, thereby compensating supply voltage fluctuations.

Exemplary specification of the autotransformer (150) for purposes of experiment as follows:
Model—10D3P having Max Load—10 A

Connection for maximum output voltage equal to the input voltage:
Input at A1, A2, A3—415 V@f=50 Hz
Output at E1, E2, E3—0→415 V@f=50 Hz

Connection for maximum output voltage higher than input voltage:
Input at B1, B2, B3—415 V@f=50 Hz
Output at E1, E2, E3—0→470 V@f=50 Hz

Exemplary specification for the motor (102) as follows:
Input—230 V AC@f=50 Hz 1ϕ
Type—SEW2; Speed—60 RPM; Torque—3 Kg-cm
Forward Operation—230 V supply on RED & WHITE
Backward Operation—230 V supply on BLUE & WHITE

The Arduino-nano microcontroller (110) including a Voltage Controller Unit is an electronic circuit designed to control the actions of the synchronous motor i.e. rotation either in forward or backward direction to maintain the output terminal voltage constant. The unit itself is powered by the supply terminals of the autotransformer through an SMPS (Switch Mode Power Supply) circuit (104) which primarily steps down the voltage to 5V and then rectifies it into DC voltage for powering up the other modules. The microcontroller (110) works on the interfacing of voltage sensors and an alpha-numeric keypad to a relay module with the help of an Arduino Nano microcontroller board.

The microcontroller (110) compares the value of voltage fed by the user through the keypad to the present output voltage of the autotransformer coming from one of the two voltage sensors (V1, V2), and gives a signal to the relay module which turns the dial accordingly to maintain the output value of voltage equal or nearly equal to the fed voltage value by the user. The overall process of the microcontroller (110) is based on the closed-loop control system.

In such a system, an initial voltage input is activated, with the autotransformer (150) initially providing no output voltage. A feedback loop is established through the voltage sensor, continuously monitoring the actual output voltage. An operator inputs a desired reference voltage into the keypad (108), which is compared to the feedback voltage by the microcontroller (110). Depending on the comparison, the microcontroller (110) activates either a forward or backward relay to adjust the autotransformer's operation, increasing or decreasing the output voltage as needed. Once the desired output voltage is achieved, it is displayed on the LCD display (106). Throughout the operation, the microcontroller (110) continuously monitors and adjusts the system (100) to minimize differences between the reference and feedback voltages, ensuring efficient regulation and minimal errors in the output voltage.

Positive closed-loop control occurs when the system's corrective action reinforces the initial change that triggered it. In the autotransformer system, positive closed-loop control is exemplified when the feedback voltage (V2f) indicates that the actual output voltage is lower than the reference voltage input by the operator. In response, the Arduino activates the forward relay, which increases the output voltage of the autotransformer by adjusting its operation. This action reinforces the initial change (increase in output voltage) required to bring the actual output voltage closer to the desired reference voltage, thereby maintaining a positive feedback loop.

Negative closed-loop control occurs when the system's corrective action opposes the initial change that triggered it. In the autotransformer system, negative closed-loop control is demonstrated when the feedback voltage (V2f) indicates that the actual output voltage is higher than the reference voltage input by the operator. In this scenario, the microcontroller (110) activates the backward relay, which decreases the output voltage of the autotransformer by adjusting its operation. By opposing the initial change (decreasing the output voltage), the system (100) aims to reduce the discrepancy between the actual and desired voltages, thereby maintaining a negative feedback loop.

In both cases, whether positive or negative closed-loop control, aim of the system (100) is to minimize the difference between the reference voltage and the feedback voltage, ensuring that the autotransformer produces the desired output voltage accurately and consistently.

Thus, the autotransformer (150) regulates the output voltage based on a user-defined reference voltage, ensuring precise voltage control and effective operation.

In another aspect of the present disclosure, an automated method (200) for maintaining output voltage of a motor-operated three-phase autotransformer (150) constant during full load conditions is disclosed, as shown in FIG. 2. The method (200) involves providing initial voltage input to the autotransformer (150) to activate thereto, followed by providing no output voltage initially. The method (200) further involves establishing a feedback loop through a voltage sensor (V1 or V2) for continuously monitoring an actual output voltage, followed by providing a desired reference voltage by an operator and comparing the reference voltage to the feedback voltage by an Arduino nano microcontroller (110). The microcontroller (110) activates either a forward or backward relay to adjust rotation of the autotransformer (150), thereby increasing or decreasing the output voltage as needed and continuously monitors and adjusts the autotransformer (150) to minimize differences between the reference and feedback voltages. The method (200) further involves displaying the achieved final output voltage is achieved on a LCD display (106).

All the components of the circuit are connected to the microcontroller (110) in various pins. The alpha-numeric keypad (108) is connected to the pins of microcontroller (110) from digital pin D9 to digital pin D2. The current sensor is connected to the analog pin A0 of Arduino Nano. Two voltage sensors (V1, V2) are connected such that the primary side voltage sensor is connected to analog pin A2 and the secondary side voltage sensor is connected to analog pin A3 of the microcontroller (110). Analog pins A4 and A5 are connected to the 20×4 LCD display (106) with an 12C interface module.

Digital pens D11 in D10 are connected to the double-channel relay with D11 as the backward relay and D10 as the forward relay. A Push button connected at the ground and reset pins of the microcontroller (110) on a board for taking input. As the rating of some of the electronic components has a limitation of 250V, and the autotransformer is rated at a maximum 470V AC line voltage, such that we are bound to use the ‘Per-Phase Analysis’ for the voltage measurement considering only Phase R and assuming a balanced condition for all the time for remaining phases.

As shown in FIG. 3, Initially, the output voltage V2f is zero. As a reference input V2r is provided with the help of the alpha-numeric keypad (108), the microcontroller (110) compares input with feedback voltage which is zero initially. For taking input buttons from 0 to 9 are used, the ‘*’ key is used to clear the fed value, and the ‘#’ key is used to execute the code.

### Increasing Output Voltage

As V2f is less than the V2r then the microcontroller (110) gives a digital signal to the forward relay which is connected to the Digital Pin D10 and make it ‘LOW’. Consequently, the motor (102) rotates in the forward direction and the tappings in the autotransformer (150) increase thus voltage increases. Such a comparison continues until the error signal becomes null such that V2f turns out equal to V2r value. The feedback signal coming from the voltage sensor is connected to the secondary side which provides feedback on the increase of each tapping. When V2f is equal to V2r the microcontroller (110) stops giving the signal to the forward relay and make it ‘HIGH’.

### Decreasing Output Voltage

If the entered value V2r is less than the V2f which is the previous value, the microcontroller (110) again does the comparison and try to reduce the error signal that, and tries to make V2f equal to V2r or the error signal less than or equal to 4 volts as V2r is less than V2f. The microcontroller (110) gives a signal to the backward relay and make it ‘LOW’ and is in ON position till the feedback voltage is not equal to the reference input voltage. As this happens, the microcontroller (110) stops giving the signal to the relay and the desired output voltage is achieved.

As the desired voltage is achieved at the output terminals, the microcontroller (110) gives a signal to the 12C module to display following data on the LCD display (106).

Input voltage (V1): This data comes from the voltage sensor which is connected to the supply terminals.

Output voltage (V2f): This is the desired voltage at the output terminals.

Turns ratio (V1/V2f): This is the ratio of input voltage to output voltage.

Load current (A): This is shown only when the load is connected.

Now if line voltage or supply voltage fluctuates, the microcontroller (110) which is continuously taking the feedback signal from the two voltage sensors (V1, V2) is aware that due to the fluctuations on the supply side, output eventually varies. Hence the microcontroller (110) instantly sends signals to the relays by comparing the feedback voltage with the reference input and keeps the output voltage constant within a range of ±4V. For instance, if supply voltage drops eventually the output voltage drops too. But the feedback is provided at the instance when the output voltage drops the microcontroller (110) sends the signal, after the comparison, to the forward relay and it increases the tappings to increase the output voltage and keep it constant. Or if supply voltage surges, the output voltage increases too. As the feedback is fed into the microcontroller (110), it senses the surge and quickly activates the backward-rotating relay such that the output voltage reduces to the specified value and maintains it there. Now to lower the voltage, a reference input is provided with the help of the alpha-numeric keypad (108). First, the push button is pressed so that the keypad (108) is ready to take the input and after entering the input voltage we will execute the code by pressing the ‘#’ key as shown in FIGS. 4A-4D.

On 12 Apr. 2024, the output of automatic control of the autotransformer (150) placed inside the Machine's Laboratory recorded at the Institute at different periods of the daytime which are morning, noon, and afternoon. As the connected load in the institution keeps on changing continuously with time, the effect can be seen in the supply voltage of the laboratory as it becomes fluctuating (minor but rapid) in nature. The output of the autotransformer (150) was monitored to see whether the output voltage varies at different loading conditions of the institute such that it remains constant even having fluctuations in the supply voltage. The observed data is represented in the table below.

| Time | V₁ (Volts) | V₂ (Volts) | T (V₁/V₂) |
|---|---|---|---|
| 11:00 AM | 417 | 417 | 1.00 |
| 12:00 PM | 420 | 415 | 1.01 |
| 01:00 PM | 433 | 414 | 1.04 |
| 02:00 PM | 406 | 415 | 0.97 |
| 03:00 PM | 415 | 416 | 1.00 |
| 04:00 PM | 426 | 415 | 1.02 |

The output of the device has remained constant irrespective of the time of the day or the value of applied input voltage. The input supply varied in the range of (400 to 430 volts) depending upon the connected load in the institute. While noting down the readings, the value of voltages keeps on changing such that the tapping was also adjusting accordingly, such that all the readings in the table were taken at instantaneous points of time, during the observation, we can justify that the variations in the value of voltages were close to the noted value.

At morning 11 am supply input was 417V (average load condition) and the output voltage recorded was 417 V.

At noon the supply input was 420V and the output voltage was 415V. The autotransformer is working in step-down mode.

At 2 pm afternoon, the supply input was 406V due to the almost full load condition in the institution which is why the input voltage dropped down, at that time, the observed output voltage was 415V. The autotransformer is now working in step-up mode.

At 4 pm the supply input was 426V, (at that period the load had dropped on the institute due to its closing time) the output recorded was 415V.

The Turns Ratio of winding continuously changed according to the requirement to nullify fluctuations and maintain the output voltage constant.

The system (100) inherits excellent accuracy of ±4V in providing a constant voltage output even during full-load operations. IoT application also helps the designed circuit to monitor four parameters at once with a refresh rate of 40 ms. The system (100) effectively compensates the supply voltage fluctuations and maintains a good voltage profile at the output terminals. The system promptly rectifies human errors and contributes towards human safety and protection of the instrument. The system (100) provides electrical isolation for safety purposes and eliminates manual labor in rotating the dial of the autotransformer.

The foregoing descriptions of exemplary embodiments of the present disclosure have been presented for purposes of illustration and description. They are not intended to be exhaustive or to limit the disclosure to the precise forms disclosed, and obviously many modifications and variations are possible in light of the above teaching. The exemplary embodiments were chosen and described in order to best explain the principles of the disclosure and its practical application, to thereby enable others skilled in the art to best utilize the disclosure and various embodiments with various modifications as are suited to the particular use contemplated.

We claim:

1. An IoT-based automated voltage controller system for motor-operated three-phase autotransformer, the controller system comprising:
a single-phase bidirectional synchronous motor mechanically connected with a shaft of the autotransformer, the motor comprising a series combination of a wire-wound resistor and a capacitor connected in parallel to the windings thereof that change tapping of windings of the autotransformer through dials;
two voltage sensors (V1, V2) connected to output of the autotransformer;
a hall effect current sensor;
a switch mode power supply (SMPS) circuit to supply power to the voltage controller unit, which primarily steps down the voltage to 5V and rectify thereto into DC voltage;
a LCD display for displaying live data such that the current through the autotransformer is not beyond the specified rating;
an alpha-numeric keypad to input target output voltage;
an Arduino-nano microcontroller associated with a plurality of modules comprising:
an input voltage module, to receive initial voltage supplied to the autotransformer to activate thereto to be operational, the initial voltage being the primary input to the autotransformer;
an initial dial positioning module, which sets the dial of the autotransformer at zero output voltage, corresponding to tapping at a primary winding's full turns;
a feedback voltage module, which receives voltage from one of the two voltage sensors to provide feedback to the microcontroller about the actual output voltage generated by the autotransformer;
a reference voltage module, which receives a reference voltage as input by an operator using the alpha-numeric keypad connected to the microcontroller;
voltage analysis module which compares the reference voltage with the feedback voltage obtained from the voltage sensor immediately as the reference voltage is received;
forward relay activation module, which activates the forward relay if the reference voltage is greater than the feedback voltage;
backward relay activation module, which activates the backward relay if the reference voltage is lesser than the feedback voltage;
voltage monitoring and adjustment module, which continuously monitors the feedback voltage and adjusts operation of the autotransformer to maintain a minimum difference of 4 Volts between the reference and feedback voltages during operation; and
display module, which displays target output voltage as achieved and other information comprising input voltage, output voltage, turns ratio (V1/V2), and line current (if any load is connected);
wherein the output voltage of the motor-operated three-phase autotransformer remains either constant or varies at +4V irrespective of nature of power supply automatically during full load conditions, thereby compensating supply voltage fluctuations.

2. The controller system of claim 1, wherein the single-phase bidirectional synchronous motor comprising a permanent magnet synchronous motor, a switched reluctance motor.

3. The controller system of claim 1, wherein the single-phase bidirectional synchronous motor is mechanically connected to the shaft of the autotransformer through a gear arrangement of gears with a gear reduction ratio of 6:1.

4. The controller system of claim 1, wherein the gear reduction increases torque required to turn the tapping shaft of the autotransformer.

5. The controller system of claim 1, wherein the reference voltage is the desired output voltage of the autotransformer.

6. The controller system of claim 1, wherein the motor turns in forward and backward directions.

7. The controller system of claim 1, wherein the motor comprising at least three limiting switches out of which two limited switches limit further rotation on either side of the windings.

8. An automated method for maintaining output voltage of a motor-operated three-phase autotransformer constant during full load conditions, the method comprising:
providing initial voltage input to the autotransformer (150) to activate thereto;
providing no output voltage initially;
establishing a feedback loop through a voltage sensor (V1 or V2) for continuously monitoring an actual output voltage;
providing a desired reference voltage by an operator;
comparing the reference voltage to the feedback voltage by an Arduino controller;
activating either a forward or backward relay to adjust rotation of the autotransformer, thereby increasing or decreasing the output voltage as needed;
continuously monitoring and adjusting the autotransformer to minimize differences between the reference and feedback voltages; and
displaying the achieved final output voltage is achieved on a LCD display.

9. The method of claim 8, wherein the method comprising activating the forward relay when the actual output voltage is lower than the reference voltage input.

10. The method of claim 8, wherein the method (200) comprising activating the backward relay when the actual output voltage is higher than the reference voltage input.
